(19) United States
(12) Patent Application Publication
(10) Pub. No.: US 2009/0190331 A1
(43) Pub. Date: Jul. 30, 2009

(54) Lock light

(76) Inventor: Carson Kelly Smith, Oregon City, OR (US)

Correspondence Address: MARK S. HUBERT P.C., 516 SE MORRISON- SUITE 1200, PORTLAND, OR, 97214, US

(21) Appl. No.: 12/012,129

(22) Filed: Jan. 30, 2008

(51) Int. Cl. E05B 17/10; F21L 4/00

(52) U.S. Cl. 362/100; 362/194

(57) ABSTRACT

A battery powered, waterproof high intensity LED enclosed in a waterproof housing that is adapted for adhesive or magnetic attachment to a surface in the proximity of a lock. A motion detector means activates the device to switch on the LED/s. A internal timing circuit ensures the hands free operation of the light as well as to ensure that the LED shuts off after a predetermined time. An angle adjusting means allows the housing to be adjusted so as to fixably alter the angle between the light beam and the housing base. A reflector means allows the beam to be concentrated and focused on the area of interest.

### BACKGROUND OF THE INVENTION

The present invention relates to a extremely compact light, able to be affixed adjacent a lock mechanism such as a padlock or a doorlock so as to provide both safety and convenience for the user. More particularly, to a battery powered, water resistant/waterproof high intensity LED enclosed in a water resistant/waterproof housing adapted for adhesive or magnetic attachment to a surface in the proximity of a lock.

Statistics show that the average American is working more hours per day now than 20 years ago. This means that more people are coming home in the dark. Inserting a key into a door's keyhole in the shadows or selecting the right key from a ring of keys in the dark, is at best a frustrating process. For those trying to unlock a padlock in an unlit darkened area, the problem is enhanced. Many automotive keys come with a small LED encased in the key housing, or have a keyless remote key fob to eliminate this problem. Unfortunately, the keys for houses, sheds, storage boxes and the like usually do not. While small LED lights are often attached to keychains, often their use is impractical as it requires the use of two hands. For example, padlocks require the use of one hand to hold the padlock and the other hand to insert the key. Further, these LEDs are not dedicated to the illumination of a specific keylock and get used for a plethora of purposes often resulting in the batteries being worn down when they are needed most. This invention utilizes a timer circuit that may or may not be combined with a motion detector means to operate the light source, hands free, for a preset period of time.

The present invention is a dedicated, mountable, water resistant/waterproof LED or multiple LED light with an adjustable beam angle that can be set and fixed to properly illuminate the area of concern about the keyhole. The beam width at the point of interest (the keyhole vicinity) may be adjusted by the distance the unit is affixed from the keyhole. Additionally, it may be set and or positioned according to it's use. It may also be used to illuminate other points of interest in unlit/darkened environments such as keypads, meters or just the general vicinity.

This new invention utilizes and combines known and new technologies in a unique and novel configuration to overcome the aforementioned problems and accomplish a long felt need.

### SUMMARY OF THE INVENTION

The general purpose of the present invention, which will be described subsequently in greater detail, is to provide a portable, low energy consumption, small source of illumination that is able to be adjustably mounted adjacent a lock and is adapted for hands off use.

It has many of the advantages mentioned heretofore and many novel features that result in a new invention which is not anticipated, rendered obvious, suggested, or even implied by any of the prior art, either alone or in any combination thereof.

In accordance with the invention, an object of the present invention is to provide an improved small, water resistant/waterproof light capable of being affixed to a surface.

It is another object of this invention to provide an improved small, water resistant/waterproof light capable of low power consumption.

It is a further object of this invention to provide an improved small, water resistant/waterproof light capable of illumination angle adjustment.

It is still a further object of this invention to provide for an improved small, waterresistant/waterproof light able to be magnetically affixed to a surface.

It is yet a further object of this invention to provide an improved small, water resistant/waterproof light affixable to any surface.

It is still a further object of this invention to provide an improved small, water resistant/waterproof light that has an internal shut off timer initiated by the button that turns on the unit.

It is still a further object of this invention to provide an improved small, water resistant/waterproof light that has an internal motion detector adapted to turn on the unit.

It is still a further object of this invention to provide an improved small, single or multiple LED light that has an internal motion detector/timer adapted to turn on the unit for a predetermined period of time.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a side view of the lock light installed on a door;

FIG. 2 is a front view of the lock light installed on a padlock;

FIG. 3 is a side view of the lock light with optional reflector means installed on a padlock; and

FIG. 4a is a side view of the preferred embodiment lock light with a magnetic base and optional reflector means;

FIG. 45 is a side view of the preferred embodiment lock light with a magnetic base and optional reflector means with a locking tabs mechanism;

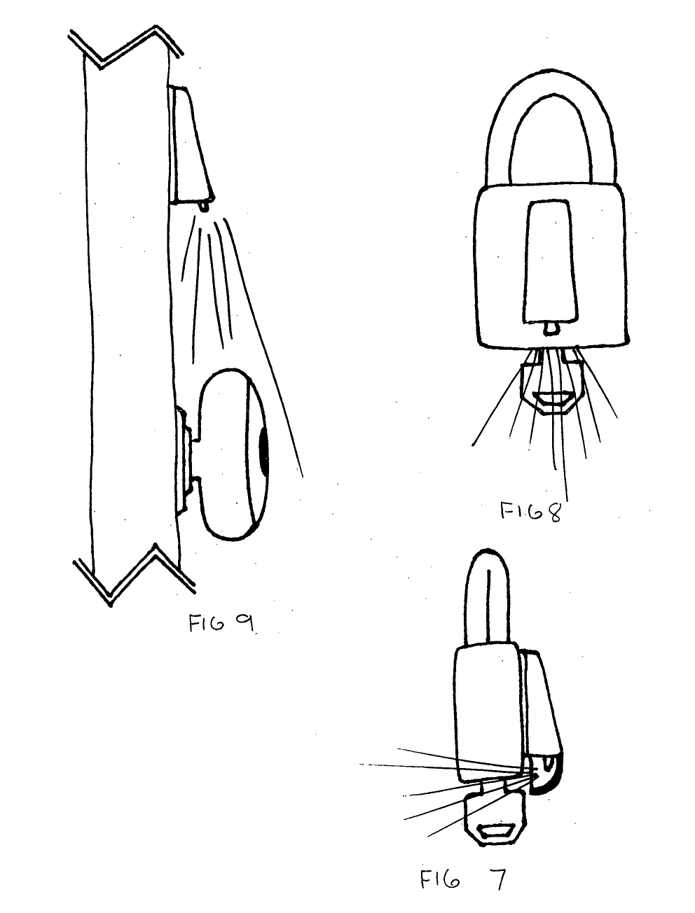

FIG. 5 is a side view of the preferred embodiment lock light with an adhesive pad;

FIG. 6 is an alternate embodiment lock light with the magnetic base replaced by a ramp adhesive base;

FIG. 7 is a side view of the preferred embodiment lock light with a reflector means attached to a padlock;

FIG. 8 is a front view of the preferred embodiment lock light attached to a padlock; and

FIG. 9 is a side view of the preferred embodiment lock light attached to a metal clad door above the keyhole.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

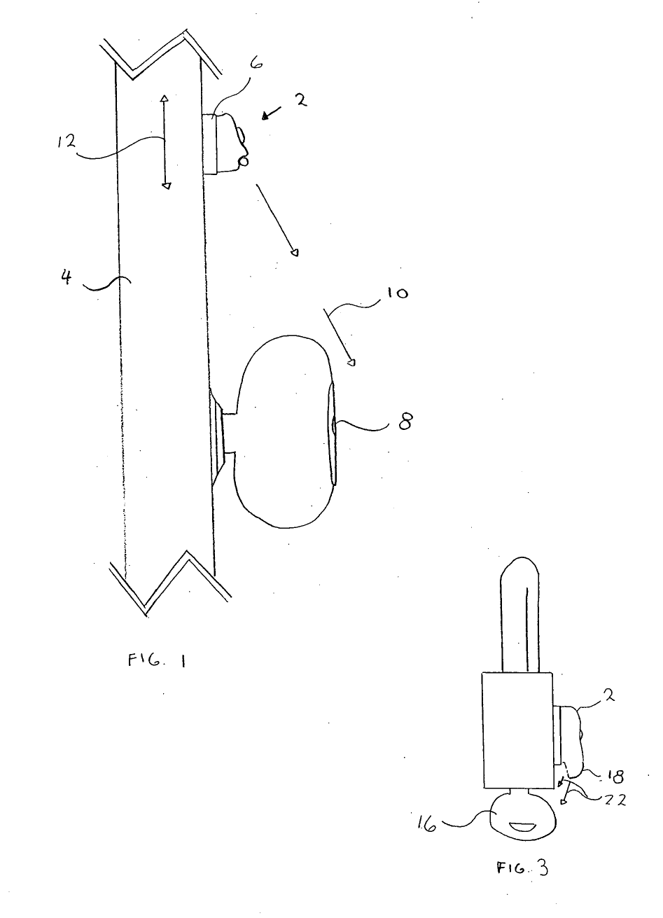

Looking at FIGS. 1-3 the use and function of the present invention can best be seen. In FIG. 1 the lock light 2 can be seen magnetically affixed by magnetic base 6 onto a metal clad exterior door 4. When turned on, the light shines at such an angle (illustrated by first directional arrow 10) so as to illuminate the key being inserted into the doorknob lock 8. The area of illumination may be adjusted by vertical placement of the lock light 2 up or down the door, as indicated by second directional arrow 12. (See FIG. 9)

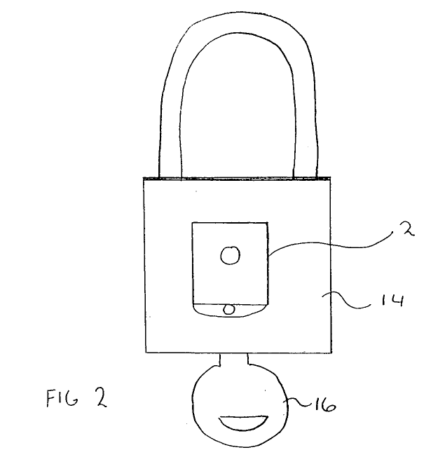

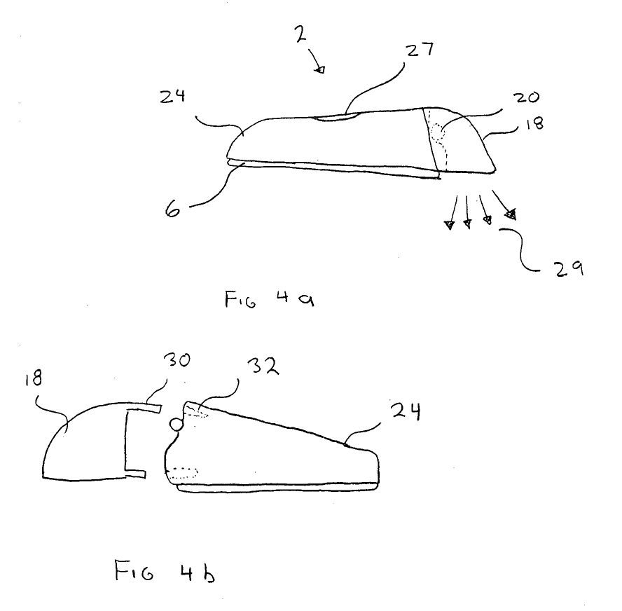

In FIGS. 2 and 3, the lock light 2 can be seen affixed to a padlock 14 so as to illuminate the key 16. In FIG. 3 the lock light 2 has a reflector means 18 adjacent the light source LED 20 so as to concentrate and direct the light in the direction indicated by third direction arrows 22. The lock light 2 may be located closer to the key 16 and the reflector means 18 adjusted so as to illuminate the key hole. In FIG. 2 the lock light 2 does not have an adjustable reflector means 18.

The lock light 2 has a LED light source 20, that projects from a water resistant/waterproof housing 24 that holds the power source (DC batteries) and the switching means components such as the circuit board, timing circuit components, resistors, and hard wiring (not illustrated.) There will also be a light activating means which may be a manual switch 26 or an automatic motion sensing switch means 27. Either of these types of light activating means may be utilized with a timer circuit to enable a timed period of illumination after activation. Construction of the present invention would be well known in the field of miniaturized flashlights.

In operation, the lock light's on switch 26 is depressed such that the LED is illuminated for a predetermined interval of time as set in the timing circuit. When Illuminated, the lock light 2 is positioned at a distance from the keyhole that allows ample illumination. The optional reflector means 18 is frictionally fit onto the housing 24 over the single or double LED's so as to narrow, intensify and further direct the light beam. The reflector means 18 is designed to direct the light as indicated by directional arrows 29 perpendicular to the longitudinal axis of the body. (See FIG. 7) This is especially useful in mounting situations such as on padlocks, meters etc., where the key insertion into the keylock is tricky or difficult. When utilized without the reflector means 18 the light merely illuminates the general vicinity of the padlock, which may make searching for keys easier.

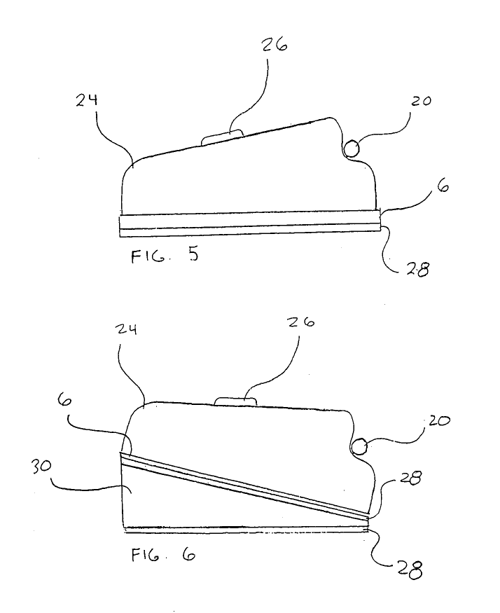

The reflector means 18 may be of a simple frictional attachment design as illustrated in FIG. 4a or have at least one tab 30 that is mechanically engageable with at least one recess 32 in the body of the lite 24 as shown in FIG. 4b. It is also known that the reflector means 18 could be attached to the body 24 by a plethora of other simple, well known mechanical methods. Further, it is also well known in the industry that there are a host of other suitable reflective and focusing devices.

In FIG. 5 a double faced adhesive pad 28 is attached to the magnetic base 6 to allow for the attachment of the light lock to non magnetic locations.

FIG. 6 shows an alternate method of adjusting the light beam. Here the angle adjusting means is a wedge 30 with two double sided adhesive pads 28 has been attached to the magnetic base 6 so as to tilt the light lock 2 in the desired direction. Note the wedge may be rotated 180 degrees before affixation, depending upon the desired direction of the light beam.

The angle adjusting means and reflector means 18 are optional and only required in certain physical configurations such as a deadbolt keyed lock.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A water resistant lock light comprising:
a housing;
a planar surfaced base upon which said housing is mounted;
an LED illumination source housed therein said housing that projects a beam of light at an acute angle with respect to the planar surface of said base;
a battery DC power source housed therein said housing;
a switching means adapted to illuminate said illumination means housed therein said housing; and
a double adhesive sided pad adapted for adhesion to said base.

2. (canceled)

3. (canceled)

4. (canceled)

5. The lock light of claim 1 wherein said base is magnetic further comprising a magnetic plate adapted for attachment to one side double adhesive sided pad

6. (canceled)

7. (canceled)

8. The lock light of claim 1 further comprising a removable reflector means frictionally attached to said housing adjacent to said LED so as to direct and concentrate a beam of light emitted from said illumination source perpendicular to a longitudinal axis of said housing.

9. The lock light of claim 5 further comprising a removable reflector means frictionally attached to said housing adjacent to said LED so as to direct and concentrate a beam of light emitted from said illumination source perpendicular to a longitudinal axis of said housing.

10. The lock light of claim 5 further comprising a wedge shaped angle adjusting means adhesively fixed thereon said housing, adapted to change the acute angle of said beam of light and said planar surface of base.

11. The lock light of claim 1 further comprising a wedge shaped angle adjusting means adhesively fixed thereon said housing, adapted to change the acute angle of said beam of light and said planar surface of base.

12. (canceled)

13. (canceled)

14. (canceled)

15. The lock light of claim 11 wherein said switching means includes a timer means adapted to stop said illumination after a preset time lapse of illumination.

16. (canceled)

17. The lock light of claim 10 wherein said switching means includes a timer means adapted to stop said illumination after a preset time lapse of illumination.

18. (canceled)

19. The lock light of claim 11 wherein said switching means includes a motion sensing switch and a timer means to automatically turn on and off said light.

20. The lock light of claim 10 wherein said switching means includes a motion sensing switch and a timer means to automatically turn on and off said light.
